(19) United States
(12) Patent Application Publication
(10) Pub. No.: US 2025/0348602 A1
(43) Pub. Date: Nov. 13, 2025

(54) ROLE BASED SYSLOG RECORD ACCESS

(71) Applicant: International Business Machines Corporation, Armonk, NY (US)

(72) Inventors: Jean MOTHERSELE, Berlin, CT (US); Trent Matthew BALTA, Poughkeepsie, NY (US); Torin REILLY, Beacon, NY (US); Michael Terrence COHOON, Fishkill, NY (US)

(21) Appl. No.: 18/660,368

(22) Filed: May 10, 2024

(51) Int. Cl. G06F 21/60; G06F 21/62

(52) U.S. Cl. CPC G06F 21/604; G06F 21/6209; G06F 21/6254

(57) ABSTRACT

Method and apparatus for providing users role-based system log entry access are described. This can be implemented using a data controller that can read and implement a policy that determines what portion of the total system log certain users (or user groups) are permitted to access. In turn, it may curate a redacted system log and present it to the user that sent the request for the system log. The data controller may act as an intermediate layer between a user wishing to view a system log, the system log itself.

### BACKGROUND

The present invention relates to a system log. A system log may refer to: a log file, an event log, a stream, or a buffer, that is a record of events that happen within a computer system, operating system, software system, etc. A system log can be used by programmers to record communications about problems, programs and system functions, among other things. It may contain sensitive information about system configuration, user activity, and security events, among other things. Different users may need to access a system log, but allowing all types of users to access the entire system log poses security threats.

Currently, solutions for limiting access to portions of a system log's information are not developed.

### SUMMARY

One embodiment herein is a method that includes receiving a request to read a system log, wherein the system log contains records of events that have occurred in a computer system; determining a user identity associated with the request; redacting portions of the system log based on a policy and the user identity, where the policy indicates data to redact from the system log according to the user identity; and providing the redacted system log to a user device.

Another embodiment herein is a system comprising a data controller configured to: receive a request from a user device to read a system log, wherein the system log contains records of events that have occurred in a computer system; determine a user identity associated with the request; redact portions of the system log based on a policy and the user identity, where the policy indicates data to redact from the system log according to the user identity; and provide the redacted system log to a user device.

Another embodiment herein is a computer program product for redacting a system log, the computer program product comprising: a computer-readable storage medium having computer-readable program code embodied therewith, the computer-readable program code executable by one or more computer processors to: receive a request from a user device to read the system log, wherein the system log contains records of events that have occurred in a computer system; determine a user identity associated with the request; redact portions of the system log based on a policy and the user identity, where the policy indicates data to redact from the system log according to the user identity; and provide the redacted system log to a user device.

### BRIEF DESCRIPTION OF THE DRAWINGS

FIG. 1 illustrates a computing environment, according to one embodiment.

FIG. 2 illustrates a computer system showing the components used to view a redacted system log, according to one embodiment.

FIG. 3 a flowchart to provide a redacted system log, according to one embodiment.

FIG. 4 illustrates where a data controller is stored, according to one embodiment.

FIG. 5 illustrates where a data controller is stored, according to one embodiment.

FIG. 6 illustrates where a data controller is stored, according to one embodiment.

FIG. 7 illustrates a flowchart for accessing a redacted system log, according to one embodiment.

FIG. 8 illustrates an example of a policy, according to one embodiment.

### DETAILED DESCRIPTION

Embodiments herein relate to a user device being presented with a redacted system log after indicating a desire to read a system log. That is, a user can be presented a redacted system log containing information pertinent to them, excluding information beyond the scope of their role. In one embodiment, a data controller uses a policy that determines what portion of the total system log certain users and (or user groups) are permitted to access. In turn, it may curate a redacted system log and present it to the user that sent the request for the system log.

Embodiments herein describe a data controller that can serve as an intermediate layer between a user wishing to view a system log, and the system log itself. The underlying system log would not be altered or modified. Rather, each user can be presented with a curated version of the system log provided by the data controller, based on the user's defined role and a policy read by the data controller.

Providing a redacted system log to users, presenting information on a need to know basis, provides a myriad of benefits. Overall, it improves information security, preventing malicious actors from gaining insights into system operations and vulnerabilities that could potentially lead to system disruption or manipulation. It can do so by minimizing the risk of data breaches. Limiting access to sensitive information helps reduce the risk of unauthorized access or accidental disclosure that could lead to a data breach. Additionally, it helps protect confidentiality, ensure compliance, enhance data integrity and streamline operations. Restricting access to information helps organizations maintain the confidentiality of sensitive data. Regulations and standards such as HIPAA, CCPA or GDPR, among others require the confidentiality of data to be maintained for such standards to be upheld. Also, limiting access to data allows organizations to have better control over their information, which may also help reduce confusion or errors that could arise from too many people having access to certain information.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a data controller 180, acting as an intermediary between a user device and a system log. In addition to data controller 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data controller 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

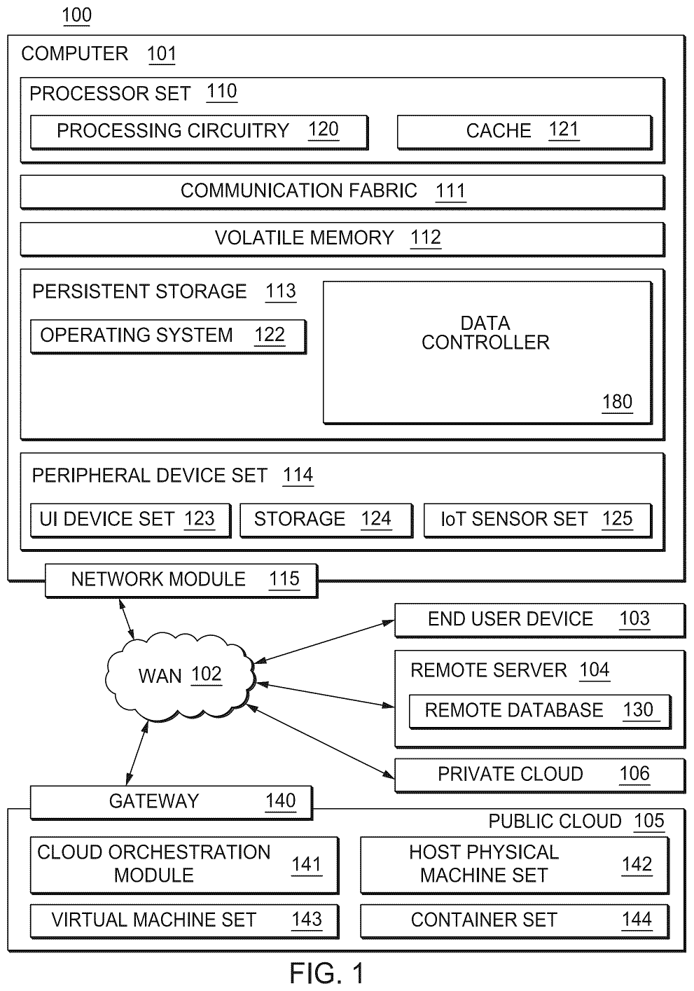

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in data controller 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in data controller 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

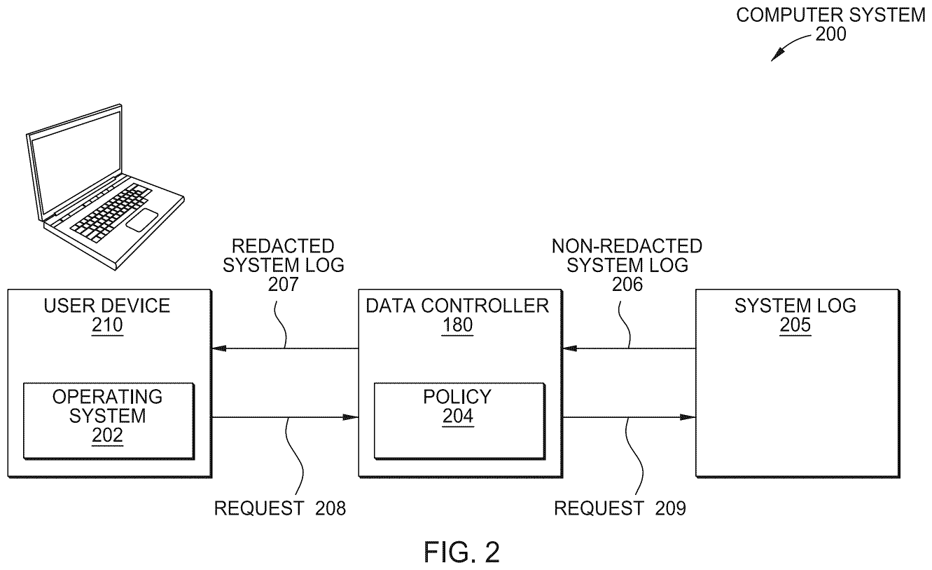

FIG. 2 depicts a computing system 200 used to curate and present a redacted system log according to the embodiments herein. The computing system 200 includes a user device 201 used by the operating system 202, a data controller 180 configured to read a policy 204, and a system log 205. The data controller 180 acts as an intermediary between the user device 210 and the system log 205. The user device 201 sends a request 208 to access the system log 205, which is received by the data controller 180. The data controller 180 sends a request 209 to read the system log 205. The computing system storing the system log 205 provides a non-redacted version of the system log (e.g., a non-redacted system log 206) back to data controller 180. After assessing the type of user requesting to view the system log 205 and considering the policy 204, the data controller 180 curates a redacted system log 207 to be presented to user device 201.

The user device 201 may be a computing device such as a laptop computer, desktop computer, or a mobile device with a central processing unit, among other types of computing devices. The user device 201 may be configured with an operating system 202 that may enable access to the system log 205. The operating system 202 may be a software meant to manage the hardware of the user device 201, providing services to connect the user device 201 with the data controller 180, the policy 204 and the system log 205. Functions of the operating system 202 may include running instances of programs on the user device 201, and managing allocation of resources to such programs (such as the CPU, memory, etc.).

Operating systems aid in the operation of computing devices and help provide a stable and secure computing environment for applications to run on. There are operating systems specific for mainframe computers in contrast to operating systems for user devices. Mainframe computers refer to high performance computer systems designed for handling complex computing tasks. Mainframes are usually used by larger organizations as a way of processing large volumes of data. They are generally reliable, scalable and secure for applications (such as an application in charge of the system log 205) that require high levels of reliability and performance.

The system log 205 may be a log file that contains records of events, messages, or activities that occur within a system. Log files may be generated by various software applications, operating systems or devices and are often used by administrators of a system, developers, or other general support personnel. Those who access a log file may do so to resolve issues logged in the log file, monitor system performance based on the data in the log file, or to ensure compliance with security and regulation, among other reasons. Information in a log file may contain timestamps of when a certain event occurred, descriptions or comments about a certain event, the importance of a particular event (which may be described with error messages, or warning messages, among other types of messages), the source of a particular event (which may include the application name, system component, or some other identifying factor), or any other relevant data surrounding a recorded event.

The system log 205 may be stored on the file system of the user device 210 or on the system generating the logged data, among a plethora of other locations. The exact location of the system log 205 may depend on the operating system 202, the application of the system log 205 or what generates the logged data itself, among other factors. For example, different operating systems store their system logs in different locations. Some operating systems store their log files in a specific directory, and specific components of the log data may be found within specific subdirectories. Web servers may store log files in an application's installation directory. Custom applications may store their log files in any directory specified by the administrator or developer of the application. These are some non limiting examples of ways of storing the log data locally.

Log files may also be stored using centralized logging solutions, which are log management systems for aggregating and storing log data from multiple devices and systems in a centralized location. This may improve management, analysis and monitoring of log data, among other things. Centralized logging solutions may collect log data from myriad sources, including but not limited to servers, applications, network devices, and security appliances. Log data may be collected in real time or in scheduled intervals. Storage of log data when using a centralized system may be in a centralized repository such as a centralized database or a distributed storage infrastructure, among other things. A distributed storage system may include storage infrastructure spanning multiple physical or virtual servers for storing and managing data. Data may be distributed across multiple nodes, which helps provide scalability, fault tolerance, and ensures availability to those wishing to access the data, among other things. Centralized logging solutions that implement a distributed storage system may be able to more capable of accommodating growing amounts of log data, as additional storage nodes may be added. Additionally, distributed storage systems may be more tolerant of hardware malfunctions, as data may be stored and replicated across many storage nodes, which allows for easier data recovery. These nodes also help with ensuring data is accessible and consistent (meaning the log may be more accurate, among other improvements). Distributed storage may be used for large data applications for storage and management of large amounts of data that may be collected across a distributed system. Centralized logging systems may also provide search and query capabilities, dashboards for viewing data, alerting capabilities, among other improvements for the user experience.

In one type of operating system, the system log 205 may be stored in a Cross-system Coupling Facility, or XCF. XCF manages communications between applications in a sysplex. Applications may be on the same system or different systems. XCF provides a centralized repository for storing information. Features of XCF may include resource sharing which facilitates the sharing of resources such as dataset and services across multiple systems, improving efficiency and utilization.

The system log 205 may also be written using a standard log file protocol. This refers to a standardized format for logging information into a log file. The protocol may define how the logged data should be formatted, what information is appropriate for the logged data to contain, and how the data should be structured within the log file, among other ways of standardization. Examples of standard file protocols include Syslog, which is a standard log protocol used for sending log messages and event notifications over a network. The syslog protocol includes a standard message format for log messages. This includes a standardization for timestamp data, application name data, and message severity level data, amongst other things. Another example may be Common Event Format (CEF), which is a standard log format for exchanging data between different systems and applications common amongst systems specific for security purposes. Event Viewer is another example of standardizing log format for recording log data accessible through applications in one type of operating system. Having a standard log file protocol makes data from different systems and applications more easily accessible for parsing, analyzing, and monitoring overall, amongst other things such as data consistency and interoperability.

In one embodiment, system logs may be written to a dataset referred to as the SYSLOG. The SYSLOG is a component that may integrate syslog protocol within its infrastructure to manage log messages. SYSLOG may be integrated with other OS components, which allow messages to be forwarded and shared amongst many systems for further processing or analysis. It may provide logging and monitoring capabilities for managing mainframe systems.

The vastness of data entered into a system log may be accessed on a need-to-know basis by employees as an improved security measure. The user device 201 may send a request 208 to access the system log 205. As an intermediary component between the system log 205 and the user device 201, the request 208 may be received first by the data controller 180. The data controller may be installed or configured within a system by a system administrator to present a redacted system log 207 to the user device 201.

Information being presented on a need-to-know basis may refer to sharing information only with individuals who may have a role where they should view such information. The role may be determined by job title, job performance, and job function, among other things. The need-to-know basis principal may be limiting access to information to minimize security risks, such as unauthorized disclosure or misuse of information. In the context of system 200, the redacted system log 207 serves an example of information being provided on a need-to-know basis.

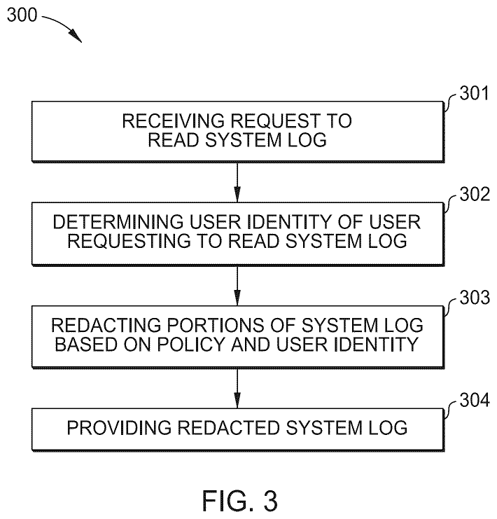

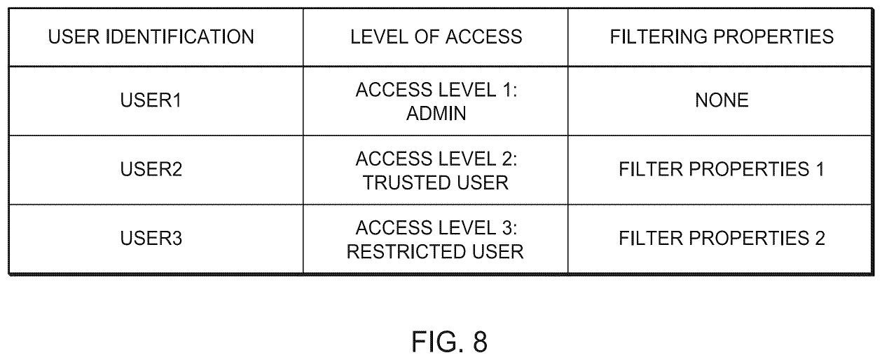

The request 208 from user device 201 may be from a user of a particular persona identifiable by the system 200. The user identity will be further discussed in FIG. 8. With the user identity in mind, and instructions from the policy 204 in mind, the data controller 180 may send a request 209 to the system log 205 to receive an underacted system log 206. The data controller 180 may then receive the non-redacted system log 206. The data controller 180 may then processes the information in the non-redacted system log 206 using the policy 204 and the user identity established from the user device 201. After the appropriate data to redact is determined, the data controller 180 sends a redacted system log 207 back to the user device 201, where the information deemed unnecessary is redacted. This will be further discussed in FIG. 3.

The data controller 180 may be an application that is an intermediary between the system log 205 and the user device 201. It may read from the policy 204 to provide the user device 201 with the appropriate redacted system log 207, based on their identity. The policy 204 may be a file in any format, for example but not limited to, XML or JSON files. The policy 204 may be located in a central location on the system or can be replicated in multiple systems through manual duplication, or file replication technology, among other ways. In the embodiment that incorporates the policy 204 in multiple locations, there may exist multiple controllers in a single environment. Each environment may therefore have its own policy. This may allow for a single user to have multiple different access levels depending on which of the multiple controllers they can access.

FIG. 3 shows process 300 of providing a redacted system log 207 to a user device 201. At block 301, the user device 201 sends a request to read the system log 205. This request 208, is received by the data controller 180. The request 208 may be signaling to read the system log 205 using a file viewer. A file viewer is a type of application meant for allowing a user to view a file's contents without editing it or modifying the contents. File viewers may be used to inspect text files, image or video files, and document files, among others. Features of file viewers include displaying the contents of a file in a format that is readable for a user (e.g. text, images, videos, etc.). File viewers may support many file formats, which may allow users to view different types of applications with the same file viewer. File viewers offer a solution for viewers to quickly view the contents of a file without opening the file itself and without making changes to the file.

The Interactive System Productivity Facility (ISPF) is a software product used for mainframe systems that contains a file viewer component. This ISPF file viewer component allows viewing the contents of log files, among other types of files. However, the embodiments herein are not limited to viewing the system log using a file viewer, and instead the system log could be presented in an editable format.

At block 302, the data controller 180 determines the user identity of the user requesting to read the system log 205. Some users will be able to see the system log 205 entirely, whereas others will only be able to see it in part, whereas others may not be able to see it at all. For example, a user with a certain identity may be granted a certain level of access, and a certain type of filtering property would be applied to the system log 205 by the data controller 180. A certain redacted system log 207 may be presented to the user device 201. This concept is further discussed in FIG. 8.

At block 303, the data controller redacts certain portions of the system log based on the policy 204 and the user identity. Access to the system log 205 is based on the policy 204, which may have granularity down to the individual user level. The policy 204 may be written according to Resource Access Control Facility (RACF) or Lightweight Directory Access Protocol (LDAP), among other technologies used for security and authentication.

RACF is a security product used for mainframe operating systems. RACF may provide access control capabilities, and it may audit access to resources within a mainframe system. It may use a set of rules to determine access rights and permissions for particular users. LDAP is a protocol used for managing and accessing information in a directory. It may be used for authentication of users by verifying their identity against an identity stored in a central directory of a system. LDAP may store information about users and may be a resource that allows information about said users to be updated. The policy 204 may define the user identity of the user requesting to access the system log according to LDAP, and may determine access based on the security capabilities of RACF. This is just one way among many others that the policy 204 may be written and implemented.

The method in which the data controller 180 determines what log data from the system log 205 may be presented in the redacted system log 207 may be according to myriad standards. These may include but are not limited to time based blocks, time based events, message identification, message text, responding system, and system level filtering, among others.

Redacting information according to time based blocks may occur if the policy 204 is defined such that users can only see entries of the system log 205 between two given timestamps. One non limiting example of this could be a type of user only being permitted to view messages added to the system log between time stamps 9 am and 5 pm. This would allow users to see messages that only logged during, say, their work hours, or give outside collaborators only certain windows where they may help debug anomalous events without allowing them to view information outside of the occurrence.

Redacting information based on time based events may be implemented in situations where administrators wish to block certain users from viewing sensitive messages until a specific event has passed. It may be possible that a specific event occurs on a system that could result in sensitive information being written into the system log 205. In this case, administrators may wish to block the time period in which this sensitive data was written, for viewing. This may be accomplished by structuring the policy 204 such that if a certain event occurs, a certain user may not be able to view certain log data from the system log 205 for a certain amount of time. Another way to structure the policy may be not allowing a user to view certain log data after the occurrence of a certain event, until the occurrence of another event.

In the context of message identification based data, another non limiting example of how to structure the policy 204 may include limiting the data a user can view based on the message identifier. The inverse implementation could be a user being excluded from seeing messages of a specific type, determined by an identifier. A message identifier may be a specific prefix identifying the type of message, or some sort of tag, among other identification techniques.

For a policy 204 configured to limit a user from reading message text, it may be configured such that administrators may direct text strings or regular expressions for the policy 204 to detect and mask appropriately. This implementation may arise in a case where administrators wish to not show, and to partially encrypt certain messages for which there are no reasonable criteria to filter on (one non limiting example may be if there are inconsistent message identifiers within the system log 205).

If policy 204 is written to limit user access based on responding systems, users may only be able to see certain messages from certain systems. This may be a predefined set of rules written into the policy 204, or it may be instructions limiting access based on a pattern written into policy 204. A non limiting example may be that a certain user may only see messages from systems of a particular group. A non limiting example of systems of a particular group may be messages stored in the system logged generated by systems that start with a particular prefix.

Policies written in the context of system level filtering may be done so to account for certain systems within an environment that have certain components of unique characteristics that are of higher importance than others. In this instance, administrators may want to filter out messages from the less important components with less important characteristics. One non limiting example of this may be where a single system is in a multi-system environment contains each of the environment's subsystems as well as additional products. It may be possible that administrators would want to limit access to the messages of the overall environment's system log to messages from just one subsystem.

At block 304, the data controller 180 provides a redacted system log 207 to the user device 201. The redacted system log 207 can include and exclude entire system log 205 entries for a particular user, while simultaneously including and excluding specific parts of the message from a particular system log 205 entry to a particular user. In one embodiment, providing the redacted system log 207 does not alter or modify the system log 205 itself. Rather, it is a curated version of the system log 205 provided by the data controller, based on the user's defined role and a policy read by the data controller.

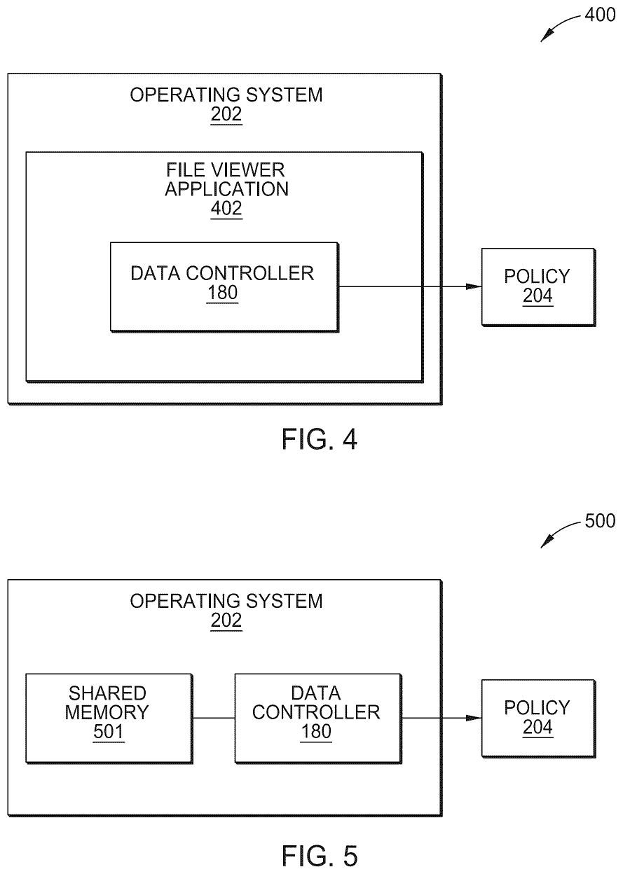

FIG. 4 illustrates an embodiment where the data controller 180 is stored within the operating system 202, within a file viewer application 402. The data controller 180 may read the policy 204 from its location within the file viewer application 402 that is included within operating system 202. In this embodiment, the data controller 180 may be a component or module embedded in the operating system 202 in the file viewer application 402 that accesses files (which may include files within the operating system 202). A non limiting example of a file viewer embedded in an operating system may be ISPF.

FIG. 5 illustrates an embodiment where the data controller 180 is running in an address space internal to the operating system 202, accessible by normal system communication means. The data controller 180 may use the shared memory 501 available in the operating system 202. An application using shared memory of an operating system may work such that a shared memory segment is created with an operating system. Once a segment is created, an application may use that segment to read and write from, and the application may be accessible by normal communication means.

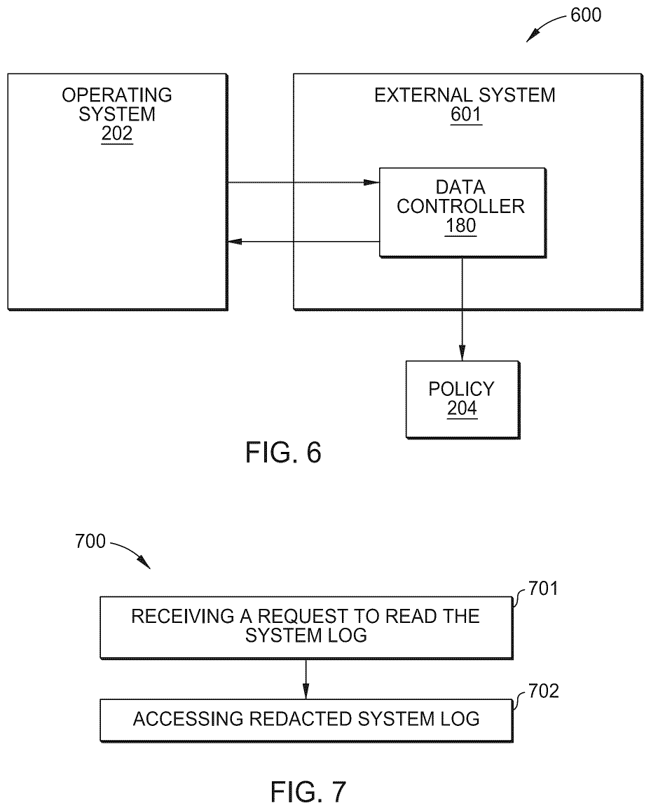

FIG. 6 illustrates an embodiment where the data controller 180 is located in an external system 601 and can be accessed by the operating system 202 using Representational State Transfer Application Programming Interface (REST API) or equivalent technology. REST API is a type of web service that allows communication between different systems. It can be defined by sending requests and receiving responses, such that a request may be sent by the operating system 202, and the response from the data controller 180 may be access to its functionality.

FIG. 7 depicts a process 700 from the perspective the user device 201.

At block 701, the user device 201 receives a request from a user to read the system log 205. This desire can be some form of a command entered into the operating system 202 indicating that a user using user device 201 wishes to view the system log 205. After this request is received, at block 702 the data controller 180 provides the user device 201 a redacted system log 207 as discussed above.

In one embodiment, the user device may perform some type of identity verification in order to authenticate the user and in turn, provide the correct redacted system log 207 to the user device 201 based on the instructions from the policy 204. In one embodiment providing in which the redacted system log 207 is presented to the user device 201, it does not alter the original system log 205. Rather, it is a curated version of the system log 205 that provides all of the information a user is allowed access to.

FIG. 8 illustrates a non limiting example of a policy 204. A policy may contain different layers, such as user identification, level of access, and filtering properties, among others.

A user identification layer may first identify the persona of the user wishing to access the system log. Personas may include but are not limited to user1, user2 and user3. When each user logs into the system and is identified, a specific access level amongst a plurality of access levels may be determined. For example, the persona user1 may be granted n first access level, access level 1, referred to as an admin. The persona of user2 may be granted a second access level, access level 2, referred to as that of a trusted user. The persona of user3 may be granted a lower third access level, access level 3, referred to as one for a restricted user. Access level 1 may be an admin access level and the access level two may be a lower access level. Once these access levels are established, appropriate filtering properties may be applied to the system log 205 to generate a redacted system log 207 with appropriate information that may be presented to the user device 201. That is, the filtering properties indicate what information should be redacted from the system log 705. Filtering properties that are applied may be certain subset of filtering properties established in a preceding access level. For example, the filtering properties of the second access level may be a subset of the filtering properties of the third access level. Or, the filtering properties of the first access level may be a subset of filtering properties from the lower second access level or third access level.

While user1, user2, and user3 are described as types or groups of users (e.g., admins, trusted users, restricted/non-trusted users, default users, etc.), the policy 800 could have specialized levels of access for particular users—e.g., John Doe has no filtering properties, John Smith has filter properties 1, and so forth.

While the foregoing is directed to embodiments of the present invention, other and further embodiments of the invention may be devised without departing from the basic scope thereof, and the scope thereof is determined by the claims that follow.

What is claimed is:

1. A method comprising:
receiving a request to read a system log, wherein the system log contains records of events that have occurred in a computer system;
determining a user identity associated with the request;
redacting portions of the system log based on a policy and the user identity, wherein the policy indicates data to redact from the system log according to the user identity; and
providing the redacted system log to a user device.

2. The method of claim 1, wherein redacting the portions of the system log further comprises:
determining an access level based on the user identity; and
determining filtering properties from the policy for the system log based on the access level.

3. The method of claim 2, wherein the filtering properties indicate which portions of the system log should be redacted.

4. The method of claim 2, wherein the policy includes a plurality of access levels, wherein filtering properties corresponding to each of the plurality of access levels are different.

5. The method of claim 4, wherein a first access level of the plurality of access levels corresponds to a first type of user identity the user identity is a first user identity, wherein a second access level of the plurality of access levels corresponds to a second type of user identity.

6. The method of claim 5, wherein the filtering properties of the first access level is a subset of the filtering properties of the second access level.

7. The method of claim 6, wherein the first access level is an admin access level and the second access level is a lower access level.

8. The method of claim 4, wherein a third access level of the plurality of access levels corresponds to a third type of user identity, wherein the filtering properties of a second access level is a subset of the filtering properties of the third access level, wherein the third access level is a lower access level than the second access level.

9. The method of claim 1, wherein a data controller that redacts the portions of the system executes on a file viewer application on the user device.

10. The method of claim 1, wherein a data controller that redacts the portions of the system executes in an external system to the user device.

11. A system, comprising:
a data controller configured to:
receive a request from a user device to read a system log, wherein the system log contains records of events that have occurred in a computer system;
determine a user identity associated with the request;
redact portions of the system log based on a policy and the user identity, wherein the policy indicates data to redact from the system log according to the user identity; and
provide the redacted system log to a user device.

12. The system of claim 11, wherein the data controller configured to redact the portions of the system log is further comprised to:
determine an access level based on the user identity; and
determine filtering properties from the policy for the system log based on the access level.

13. The system of claim 12, wherein the filtering properties indicate which portions of the system log should be redacted.

14. The system of claim 12, wherein the policy includes a plurality of access levels, wherein filtering properties corresponding to each of the plurality of access levels are different.

15. A computer program product for redacting a system log, the computer program product comprising:
a computer-readable storage medium having computer-readable program code embodied therewith, the computer-readable program code executable by one or more computer processors to:
receive a request from a user device to read the system log, wherein the system log contains records of events that have occurred in a computer system;
determine a user identity associated with the request;
redact portions of the system log based on a policy and the user identity, wherein the policy indicates data to redact from the system log according to the user identity; and
provide the redacted system log to a user device.

16. The computer program product of claim 15, wherein the computer-readable program code is further executable to:
determine an access level based on the user identity; and
determine filtering properties from the policy for the system log based on the access level.

17. The computer program product of claim 16, wherein the filtering properties indicate which portions of the system log should be redacted.

18. The computer program product of claim 16, wherein the policy includes a plurality of access levels, wherein filtering properties corresponding to each of the plurality of access levels are different.

19. The computer program product of claim 16, wherein the filtering properties of a first access level is a subset of the filtering properties of a second access level.

20. The computer program product of claim 19, wherein the first access level is an admin access level and the second access level is a lower access level.
